(19) United States
(12) Patent Application Publication
(10) Pub. No.: US 2020/0344517 A1
(43) Pub. Date: Oct. 29, 2020

(54) ELECTRONIC DEVICE AND CONTROL METHOD THEREOF

(71) Applicant: SAMSUNG ELECTRONICS CO., LTD., Suwon-si, Gyeonggi-do (KR)

(72) Inventors: Youngin Park, Suwon-si (KR); Sungmin Lim, Suwon-si (KR); Sumin Kim, Suwon-si (KR); Younghyun Kim, Suwon-si (KR); Hanjin Park, Suwon-si (KR); Seockyoung Shim, Suwon-si (KR); Taehoon Lee, Suwon-si (KR); Changwon Choi, Suwon-si (KR)

(73) Assignee: SAMSUNG ELECTRONICS CO., LTD., Suwon-si, Gyeonggi-do (KR)

(21) Appl. No.: 16/961,129

(22) PCT Filed: Dec. 19, 2018
(86) PCT No.: PCT/KR2018/016178

§ 371 Date: Jul. 9, 2020

(30) Foreign Application Priority Data
Jan. 23, 2018 (KR) 10-2018-0008439

(51) Int. Cl. H04N 21/431; H04N 21/475; H04N 21/41

(52) U.S. Cl. CPC H04N 21/4312; H04N 21/4126; H04N 21/475

(57) ABSTRACT

The present disclosure relates to an electronic device and a control method thereof. The electronic device according to the present disclosure comprises: a display; a communication unit; and a processor configured to receive information on an idle screen generated on the basis of category information on a plurality of contents selected by a user through the communication unit, and to control the display to display the idle screen on the basis of information on the received idle screen, wherein the idle screen includes a plurality of elements corresponding to a plurality of categories in which a plurality of contents are classified.

### TECHNICAL FIELD

The disclosure relates to an electronic device and a control method thereof, and more specifically to an electronic device which may display a standby (ambient) screen including various information on the standby screen, and to a method of changing a standby screen based on changes to the included information.

### BACKGROUND ART

Recently, functions providing variety of user experience are being developed using electronic devices. For example, a display device may not only simply playback broadcast content, but also display masterpiece paintings, landscape pictures, and the like for aesthetical purposes.

However, in the case of conventional display devices, pictures and images which were pre-set by the user were present in still form, and it was not possible to provide various information to the user.

### DISCLOSURE

### Technical Problem

The disclosure provides an electronic device which intuitively provides information desired by the user when a standby screen which operates in a standby mode is displayed and a control method thereof.

### Technical Solution

According to an embodiment, an electronic device includes a display, a communicator, and a processor configured to receive information on a standby screen generated based on category information a plurality of contents selected by the user through the communicator, and control the display to display a standby screen based on information on the received standby screen, and the standby screen includes a plurality of elements corresponding to a plurality of categories in which a plurality of contents are classified.

The processor may be configured to, based on information on the standby screen being changed, receive the changed standby screen information through the communicator, and control the display the standby screen by changing the plurality of elements based on the changed standby screen information and displaying.

The processor may be configured to control the display to display the standby screen in a standby mode, and control the display to display content in a content mode.

The processor may be configured to, based on power being applied to the display to operate in the standby mode in a state in which power is not applied to the display, receive information on a standby screen generated based on category information on the plurality of contents selected by a user through the communicator.

The processor may be configured to, based on the display being changed from the content mode to the standby mode, receive information on the standby screen generated based on category information on a plurality of contents selected by a user through the communicator.

The change of element may be any one of deleting any one of the at least one element, adding a new element, or changing size or color of the element.

The processor may be configured to, based on the electronic device operating in the standby mode, control the display to display a background image layer including the at least one element and a screen including an object layer including a graphic object.

The processor may be configured to, based on the electronic device operating at the standby mode, control the display to display a weather graphic object corresponding to an outside weather information on the object layer.

According to another embodiment, a control method of an electronic device includes receiving information on a standby screen generated based on category information on a plurality of contents selected by the user, and displaying a standby screen based on information on the received standby screen, and the standby screen includes a plurality of elements corresponding to a plurality of categories in which the plurality of contents is classified.

The displaying may further include, based on information on the standby screen being changed, receiving the changed standby screen information, and displaying the standby screen by changing the plurality of elements based on the changed standby screen information.

The displaying includes controlling the display to display the standby screen in the standby mode, and displaying the content in content mode.

The receiving may include, based on power being applied to the display for operating in the standby mode in a state in which power is not applied to the display, receiving information on the generated standby screen based on category information on the plurality of contents selected by a user.

The receiving may include, based on the display of the electronic device being converted from the content mode to the standby mode, receiving information on the standby screen generated based on category information on a plurality of contents selected by a user.

The changing of the element may be one of deleting any one of the at least one element, adding new element, and changing size or color of the element.

The displaying may further include, based on the electronic device operating in the standby mode, displaying a screen including a background image layer including the at least one element and an object layer including a graphic object.

The displaying may further include, based on the electronic device operating in the standby mode, displaying a weather graphic object corresponding to outside weather information on the object layer.

### Effect of Invention

According to various embodiments, a standby screen may provide various information to a user.

### DESCRIPTION OF DRAWINGS

FIG. 1 is an exemplary view illustrating a system according to an embodiment of the disclosure;

FIG. 2 is a block diagram briefly illustrating a configuration of an electronic device according to an embodiment of the disclosure;

FIG. 3 is a block diagram specifically illustrating a configuration of an electronic device according to an embodiment of the disclosure;

FIGS. 4A to 9B are exemplary views illustrating a standby screen display method of an electronic device according to various embodiments of the disclosure; and

FIG. 10 is a flowchart illustrating a control method of an electronic device according to an embodiment of the disclosure.

### DETAILED DESCRIPTION OF EXEMPLARY EMBODIMENTS

Various modifications may be made to the various embodiments, and various types of embodiments may result therefrom. Accordingly, specific embodiments may be illustrated in drawings, and described in greater detail in the detailed description. However, it should be noted that the various embodiments are not for limiting the scope of the disclosure to a specific embodiment, and should be interpreted to include all modifications, equivalents or alternatives of the embodiments included in the idea and the technical scope disclosed herein. In describing the embodiments, based on determining that the detailed description of the related known technologies may confuse the gist of the disclosure, the detailed description thereof may be omitted.

The terms such as first, second, and the like may be used to describe a variety of elements, but the elements should not be limited by these terms. The terms may be used only for the purpose of distinguishing one element from another element.

The terms used herein have been used only to describe a specific embodiment, and it is not intended to limit the scope of the claims. A singular expression may include a plurality of expressions unless otherwise clearly specified in context. It should be understood that terms such as “comprise” or “consist of” used herein are to designate a presence of a characteristic, number, step, operation, element, component, or a combination thereof, and not to preclude a presence or a possibility of adding one or more of other characteristics, numbers, steps, operations, elements, components or a combination thereof.

The terms ‘module’ or ‘part’ used in the embodiments herein perform at least one function or operation, and may be implemented as a hardware or software, or a combination of hardware and software. Further, a plurality of ‘modules’ or a plurality of ‘parts’, except for a ‘module’ or a ‘part’ which needs to be implemented to a specific hardware, may be integrated to at least one module and implemented in at least one processor (not shown).

In the disclosure, a method of an electronic device including a display to display various content screens has been described, but the embodiment is not limited thereto. That is, the electronic device may consist of a set-top box and an over the top device (OTT). The electronic device, in this case, may transmit an image signal to an external display device, and the external display device which received the image signal may display various content screens. Herein, for convenience of description and understanding, the electronic device 100 including a display has been described, but as described above, the electronic device 100 not including a display may also be applicable to the technical concept of the disclosure.

According to an embodiment, the electronic device may include a plurality of operation modes. The plurality of operation modes may include a first operation and a second operation mode. The first operation mode, which is one of a plurality of operation modes, may refer to a mode of displaying a normal image. Specifically, the first operation mode may be a mode of displaying a pre-stored content in the electronic device or a broadcast received externally using a whole screen of the electronic device. Although, it has been designated as the first operation mode for the convenience of description, it may be designated to other designations such as a normal mode or a content mode. In the disclosure, it will be referred to as a content mode.

When in the first operation mode, not only a normal image but also a specific content object may be displayed together. The specific content object may be an object including information on the normal image, and may be an object including information on a viewable channel.

The second operation mode, which is another operation mode of the electronic device, may display a screen including an image in a standby (ambient) screen. For convenience of description, the second operation mode may be designated as an ambient mode, a standby screen mode, a standby mode, and the like. Herein, it will be referred to as a standby mode.

The disclosure will be described in detail below using the accompanying drawings.

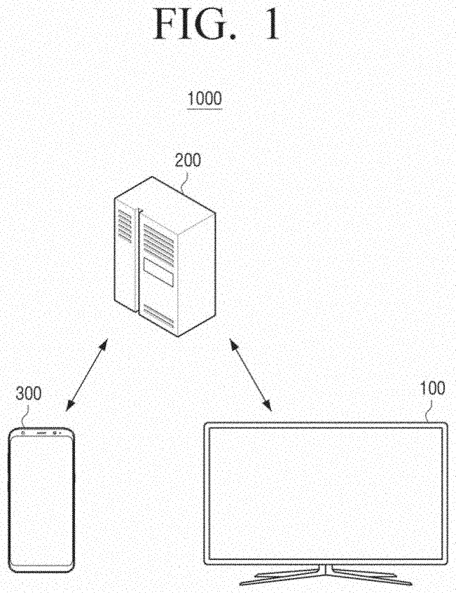

FIG. 1 is an exemplary view illustrating an electronic device, a server, and a system including a user terminal according to an embodiment of the disclosure.

The system 1000 according to the disclosure may include an electronic device 100, a server 200, and an external electronic device 300.

The electronic device 100 may refer to a variety of devices including a display. The electronic device 100 may receive a standby screen information from a server 200. The electronic device 100 may display the received standby screen, and the standby screen may include a plurality of elements.

For example, the electronic device 100 may consist of a TV, a smartphone, a tablet personal computer (PC), a mobile phone, an image phone, an e-book reader, a desktop PC, a laptop PC, netbook computer, and the like. According to another embodiment, the electronic device 100 may be a home appliance. The home appliance may include at least one of, for example, a television, a digital video disk (DVD) player, an audio, a refrigerator, an air conditioner, a vacuum cleaner, an oven, a microwave oven, a washing machine, an air purifier, a set-top box, a home automation control panel, a security control panel, a TV box (e.g., Samsung HomeSync™, Apple TV™, or Google TV™), game consoles (e.g., Xbox™, PlayStation™), an electronic dictionary, an electronic key, a camcorder, or an electronic frame.

The external electronic device 300 may be configured for transmitting various data to the server 200. The external electronic device 300 may include at least one of a smartphone, a tablet PC, a mobile phone, a video telephone, an e-book reader, a desktop PC, a laptop PC, a netbook computer, a workstation, a server, a personal digital assistant (PDA), a portable multimedia player (PMP), an MP3 player, a mobile medical device, a camera, or a wearable device. According to the various embodiments, the wearable device may include at least one of an accessory type (e.g., a watch, a ring, a bracelet, an anklet, a necklace, a pair of glasses, a pair of content lenses, or a head-mounted-device (HMD); a fabric or a garment-embedded type (e.g., electronic clothing); a body attachable type (e.g., a skin pad or a tattoo), or a bio-implantable type (e.g., implantable circuit).

According to another embodiment, the electronic device 300 may be a home appliance. The home appliance may include at least one of, for example, a television, a digital video disk (DVD) player, an audio, a refrigerator, an air conditioner, a vacuum cleaner, an oven, a microwave oven, a washing machine, an air purifier, a set-top box, a home automation control panel, a security control panel, a TV box (e.g., Samsung HomeSync™, Apple TV™, or Google TV™), game consoles (e.g., Xbox™ PlayStation™), an electronic dictionary, an electronic key, a camcorder, or an electronic frame.

According to still another embodiment, the electronic device 300 may include at least one of a variety of medical devices (e.g., various portable medical measurement devices (a blood glucose meter, a heart rate meter, a blood pressure meter, a temperature measuring device, etc.), a magnetic resonance angiography (MRA), a magnetic resonance imaging (MRI), a computed tomography (CT), a photographing device, an ultrasonic wave device, etc.), navigation devices, global navigation satellite system (GNSS), event data recorder (EDR), flight data recorder (FDR), vehicle infotainment device, marine electronic equipment (e.g., a marine navigation device, a gyro compass, etc.), avionics, security devices, vehicle head units, industrial or domestic robots, automated teller machine (ATM) of financial institutions, points of sale (POS) of stores, or Internet of Things (IoT) devices (e.g., light bulbs, various sensors, electric or gas meters, sprinkler devices, fire alarms, thermostats, street lights, toasters, exercise equipment, hot water tanks, heater, boiler, etc.).

According to still another embodiment, the external electronic device 300 may include at least one of a furniture or a part of building/structure, an electronic board, an electronic signature receiving device, a projector, or various measurement equipment (e.g., water, electricity, gas, or radio wave measuring equipment, etc.).

The server 200 may be a configuration for obtaining a standby screen to be transmitted to the electronic device 100 by analyzing various data received from the external electronic device 300. The sever 200 according to the embodiment may be configured not only as a single server, but also as a plurality of servers.

In FIG. 1, the electronic device 100 and the external electronic device 300 has been illustrated as not in communication with each other, but the embodiment is not limited thereto. The electronic device 100 and the external electronic device 300 may communicate with each other without going through the server 200.

Although the disclosure describes of a system including the electronic device 100, the server 200, and the external electronic device 300, the embodiment is not limited thereto. That is, the electronic device 100 may perform a function of the electronic device 100 and the server 200 on its own, and the electronic device 100 may also perform all functions of the electronic device 100, the server 200, and a user terminal device 300.

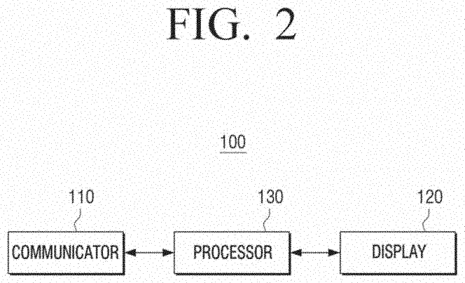

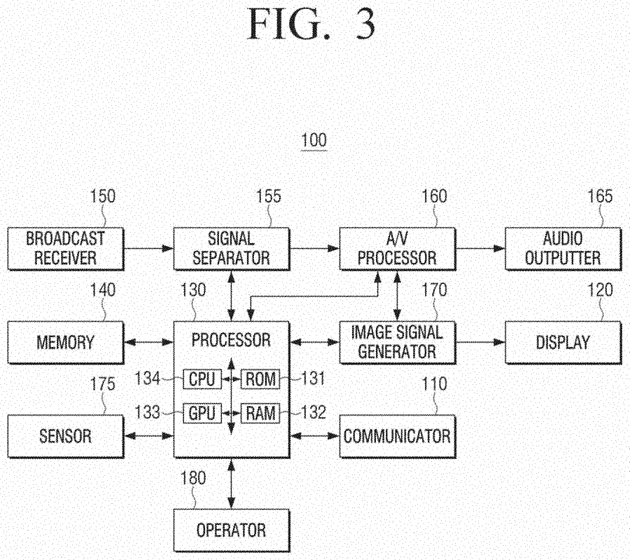

FIG. 2 is a block diagram briefly illustrating a configuration of an electronic device according to an embodiment of the disclosure.

As illustrated in FIG. 2, the electronic device 100 may include a communicator 110, a display 120, and a processor 130.

The communicator 110 may receive various information externally. Specifically, the communicator 110 may receive information on the standby screen from the server 200.

The display 120 may display image data. Specifically, while the electronic device 100 is being operated in the content mode, the display 120 may display image content obtained from an external source (e.g., broadcasting station, server, DVD, etc.). In addition, while the electronic device 100 is being operated in the standby mode, the display 120 may display a standby screen corresponding to the standby screen information received through the communicator 110. Further, the display 120 may not only display the standby screen received from the server 200, but also display a pre-stored screen to the electronic device 100.

The processor 130 may control the overall operations of the electronic device 100. Specifically, the processor 130 may be configured to control the display to receive information on a standby screen generated based on category information on a plurality of contents selected by the user through the communicator 110, and display a standby screen based on the received standby screen information.

The standby screen may include a plurality of elements corresponding to a plurality of categories in which the plurality of contents are classified. For example, the plurality of categories may be various such as a sports category, an entertainment category, and a music category, and the plurality of elements may be an image corresponding to each category.

The information on the standby screen may be decided based on various data. For example, the data may be bookmark information, schedule information, and memo information input from the external electronic device 300.

Alternatively, if the external electronic device 300 is a variety of devices connected by internet of things (IoT), it may be data detected from the variety of devices. For example, if the external electronic device 300 is a door lock, the data may be data on an opened door state. Alternatively, if the external electronic device 300 is lighting, the data may be data related to the turned-on or turned-off state of lighting.

Alternatively, the data may be user data input externally through the electronic device 100. For example, the data may data on a scheduled viewing information, data related to an interest channel, and the like.

Alternatively, the data may be data detected through the electronic device 100. For example, the data may be data which detects users in the periphery of the electronic device 100.

The data in the disclosure has been described based mainly on a bookmark data, but the various data described above may also be applicable to the technical concept of the disclosure.

When data belonging to the plurality of categories is changed by the above-described various data being input, the plurality of elements may be changed based on the change of data. For example, when one element of the plurality of elements is the element corresponding to the sports category and bookmark information on one hundred sports uniform resource locators (URLs) in the sports category is included, the element corresponding to the sports category may be a size (or color, texture, image, etc.) corresponding to the one hundred bookmark information.

The change of element may be in various forms. For example, if the size of the element, color, or texture is changed, a new effect (i.e., application of animation effect and various filters) may be added.

If the information on the standby screen is changed, the processor 130 may receive the changed standby screen information through the communicator 110, and control the display 120 to display a plurality of elements based on the changed standby screen information. For example, if the external electronic device 300 transmits a plurality of bookmark information to the server 200, the server 200 may classify the received bookmark information based on the plurality of categories to change the standby screen information. The processor 130 may change the plurality of elements based on the changed standby screen information and display. For example, based on the plurality of bookmark information transmitted by the external electronic device 300 being bookmark information on a sports category and a music category, the processor 130 may change the size (or color, texture, image, etc.) of the element corresponding to the sports category and the element corresponding to the music category.

The change of element may be any one of deleting any one of the at least one element, adding new element, or changing the size or color of the element.

The standby screen as indicated above may operate in the standby mode. That is, the processor 130 may be configured to control the display 120 to display a standby screen including the above-described plurality of elements in the standby mode. In addition, the processor 130 may be configured to control the display 120 to display various content in the content mode.

If operated in the standby mode, the processor 130 may reduce power consumption of the electronic device 100 through various methods. According to an embodiment, the processor 130 may receive information on the standby screen from the server 200 only when a specific condition is satisfied, operate in the standby mode only when a specific condition is satisfied, or change the element only when a specific condition is satisfied.

Specifically, when power is applied to the display 120 for operating in the standby mode in a state in which power is not applied to the display 120, the processor 130 may receive information on the standby screen generated based on category information on the plurality of contents selected by the user through the communicator 110. That is, the processor 130 may not receive the standby screen information from the server 200 if power is not applied to the display 120.

The condition for power being applied to the display 120 may be varied. For example, when user inputs a user command for operating in the standby mode, the processor 130 may be configured to receive the standby screen information from the server 200, and control the display 120 to display the standby screen in the standby mode. Alternatively, when a user is detected in the periphery of the electronic device 100, the processor 130 may be configured to receive the standby screen information from the server 200, and control the display to display the standby screen in the standby mode.

Alternatively, when the display 120 is converted to the standby mode while operating in the content mode, the processor 130 may be configured to receive information on the standby screen generated based on the category information on the plurality of contents selected by the user through the communicator 110. That is, the processor 130 may not receive the standby screen information from the server 200 when the display 120 is operating in the content mode, and may receive the standby screen information from the server 200 when the operation mode is changed to the standby mode.

In addition to the above-described methods, the processor 130 may receive standby screen information from the server 200 based on a predetermined time (e.g., 4 hours) period. Alternatively, the processor 130 may be configured to receive the standby screen information from the server 200 at a time (e.g., early hours or a time determined based on user behavior) at which the user is not using the electronic device 100.

The processor 130 may be configured to, while the electronic device 100 is operating in the standby mode, control the display 120 to display a screen including the object layer including the background image layer including the at least one element and the graphic object.

When the electronic device 100 is operating in the standby mode, the processor 130 may be configured to control the display 120 to display a weather graphic object corresponding to the outside weather information or a clock graphic object corresponding to current time information on an object layer.

FIG. 3 is a block diagram illustrating a specific configuration of an electronic device according to an embodiment of the disclosure. Referring to FIG. 3, the electronic device 100 according to an embodiment may include a communicator 110, a display 120, a memory 140, a processor 130, a broadcast receiver 150, a signal separator 155, an A/V processor 160, an audio outputter 165, an image signal generator 170, a sensor 175, and an operator 180.

However, the embodiment is not limited to the above-described configuration, and some configurations may be added, omitted, or incorporated based on necessity. For example, the processor 130 may be a configuration including a signal separator 155, an A/V processor 160, and an image signal generator 170. In this case, the processor 130 may perform functions and operations of the A/V processor 160 and the image signal generator 170 which will be described hereafter. The communicator 110 may be a configuration performing communication with external devices of various types based on the communication methods of various types. The communicator 110 may include a Wi-Fi chip and a Bluetooth chip. The processor 130 may perform communication with various external devices using the communicator 110. Specifically, the communicator 110 may receive control instructions or user interactions from the control terminal device (e.g., smartphone, remote controller) capable of controlling the electronic device 100.

Alternatively, the communicator 110 may receive various data from the server 200. For example, the communicator 110 may obtain standby screen information, weather information, and the like through communication with the server 200. The processor 130 may generate a background image using the weather information obtained through the communicator 110.

In addition thereto, although not illustrated in FIG. 2, according to an embodiment, the communicator 110 may further include a universal serial bus (USB) port to which the USB connector may be connected, various external input ports for connecting with various external terminals such as a headset, mouse, and local area network (LAN), or a digital multimedia broadcasting (DMB) chip for receiving and processing a DMB signal.

The display 120 may display an image. The display 120 may be implemented to a display of various types such as a liquid crystal display (LCD) and a plasma display panel (PDP). In the display 120, a driving circuit capable of being implemented to a form such as an amorphous silicon thin film transistor (a-si TFT), a low temperature poly silicon (LTPS) TFT, and an organic TFT (OTFT), a backlight unit, and the like may be included therewith. The display 120 may be combined with a touch detection sensor to be implemented as a touch screen.

The display 120 may include a backlight. The backlight may be a point light source consisting of a plurality of light sources, and may support local dimming.

The light source consisting the backlight may be configured to a cold cathode fluorescent lamp (CCFL) or a light emitting diode (LED). Although the backlight has been illustrated and described below as being configured to a LED and a LED driving circuit, upon implementation, the backlight may be implemented as another configuration other than the LED. The plurality of light sources consisting the backlight may be disposed in various forms, and various local dimming technique may be applied. For example, the backlight may be a direct type backlight in which a plurality of light sources is disposed in a matrix type and disposed uniformly on the whole of the liquid crystal display (LCD). In this case, the backlight may be operated in a full-array local dimming method or a direct local dimming method. The full-array local dimming may be a dimming method in which the light source is uniformly and as a whole disposed in its entirety behind an LCD screen, and a brightness adjustment for each light source may be performed. Further, although the direct local dimming may be similar with the full-array local dimming method, it may be a dimming method performing brightness adjustment for each light source with a smaller number of light sources.

In addition, the backlight may be an edge type backlight in which a plurality of light sources are disposed only at the edge part of the LCD. In this case, the backlight may be operated in an edged-lit local dimming method. In the edge-lit local dimming, the plurality of light sources may be disposed only at an edge of the panel, disposed only at the left/right edges of the panel, disposed only at the top/bottom edges of the panel, or disposed at the left/right/top/bottom edges of the panel.

Specifically, the display 120 may display a standby screen including a background image. The standby screen may include a standby screen layer and a graphic object layer.

In addition, while the display 120 is operated in the content mode, the display may be driven with a first frequency (e.g., 120 Hz or 240 Hz), and while the display 120 is operated in the standby mode, the display 120 may be driven at a second frequency (e.g., 60 Hz) which is lower than the first frequency. That is, based on driving the display 120 at a low frequency while operating in the standby mode, power consumption may be minimalized.

The broadcast receiver 150 may receive and demodulate wired or wireless broadcasts from a broadcasting station or a satellite. Specifically, the broadcast receiver 150 may receive and demodulate a transport stream through an antenna or a cable to output a digital transport stream signal.

The signal separator 155 may separate the transport stream signal provided from the broadcast receiver 150 to an image signal, an audio signal and an additional information signal. The signal separator 155 may then transmit the image signal and the audio signal to the A/V processor 160.

The A/V processor 160 may perform signal processing of the image signal input from the broadcast receiver 150 and the memory 140 and a video decoding on the audio signal, a video scaling, an audio decoding, and the like. The A/V processor 160 may then output the image signal to the image signal generator 170, and output the audio signal to the audio outputter 165. The image output through the image signal generator 170 may be a content image by the content mode.

On the other hand, based on the received image and audio signal being stored in the memory 140, the A/V processor 160 may output the image and the audio to the memory 140 in a compressed form.

The audio outputter 165 may convert the audio signal output from the A/V processor 160 to sound to output through a speaker (not shown), or output to an external device connected through an external output terminal (not shown).

The image signal generator 170 may generate a graphic user interface (GUI) for proving to a user. The image signal generator 170 may add the generated GUI to an image output from the A/V processor 160. The image signal generator 170 may then provide an image signal corresponding to the image added with the GUI to the display 120. Accordingly, the display 120 may display the various information provided by the electronic device 100 and the images transmitted from the image signal generator 170.

The image signal generator 170 may process and output a content screen generated by the processor 130. If the image generated by the image signal generator 170 includes a plurality of layers, the image signal generator 170 may output the plurality of layers as is or the plurality of layers may be synthesized (or merged) and provided to the display 120.

The memory 140 may store various data and programs to control the electronic device 100. In addition, the memory 140 may receive and store an image content with the image and audio compressed from the A/V processor 160, and output the stored image content to the A/V processor 160 based on the control of the processor 130. Specifically, the memory 140 may store data on the background image.

The memory 140 may be implemented as a hard disk, a non-volatile memory, a volatile memory, and the like.

The operator 180 may be implemented as a touch screen, a touch pad, a key button, a key pad, and the like, and may provide user manipulation of the electronic device 100. In the embodiment, an example of receiving input of a control instruction through the operator 180 provided on the electronic device 100 has been described, but the operator 180 may receive input of a user manipulation from an external control device (e.g., remote controller).

The sensor 175 may detect user interaction. That is, the user interaction may, as described above, not only be received from the external device, but also detected from the sensor 175.

Specifically, according to an embodiment, the sensor 175 may be a camera sensor or an infrared (IR) sensor for detecting a user in the periphery of the electronic device 100. If a user is detected, the processor 130 may be configured to display a standby screen corresponding to the detected user. For example, if a first user is detected in the periphery of the electronic device 100, the processor 130 may be configured to control the display 120 to display a first standby screen corresponding to a first user, and if a second user is detected in the periphery of the electronic device 100, the processor 130 may be configured to control the display 120 to display a second standby screen corresponding to a second user. Alternatively, if a first user and a second user are both detected in the periphery of the electronic device 100, the processor 130 may be configured to control the display 120 to display by synthesizing the first standby screen corresponding to the first user and the second standby screen corresponding to the second user.

According to another embodiment, the sensor 175 may be a touch sensor which detects a touch input of a user.

According to still another embodiment, the sensor 175 may be an illuminance sensor. The processor 130 may be configured to obtain an ambient illuminance value through the illuminance sensor, and adjust the illuminance of the standby screen based on the obtained illuminance.

In addition thereto, the sensor 175 may further include various sensors such as an IR sensor, an ultrasonic sensor, and an RF sensor.

The processor 130 may be configured to control the overall operations of the electronic device 100. Specifically, the processor 130 may be configured to control the image signal generator 170 and the display 120 to display an image based on the control instruction received through the operator 180 while the processor 130 is in the first operation mode.

The processor 130 may be implemented in the form of a system of chip (SoC) including a read only memory (ROM) 131, a random access memory (RAM) 132, a graphic processing unit (GPU) 133, a central processing unit (CPU) 134, and a bus. The ROM 131, the RAM 132, the GPU 133, the CPU 134 and the like may be interconnected through the bus.

The CPU 134 may access the memory 140, and may perform booting using the operating system (O/S) stored in the memory 140. The CPU 134 may then perform various operations using the various programs, content, data, and the like stored in the memory 140.

In the ROM 31, an instruction set and the like may be stored for system booting. When a turn-on instruction is input and power is supplied, the CPU 134 may copy the O/S stored in the memory 140 to the RAM 132 based on the stored instruction in the ROM 131, and may boot the system by executing the O/S. When booting is completed, the CPU 134 may copy the various programs stored in the memory 140 to the RAM 132, and execute the program copied to the RAM 132 to perform various operations.

The GPU 133 may, when booting of the electronic device 100 is completed, generate a screen including various objects such as an icon, an image, and a text. Specifically, when the electronic device 100 is operating in the standby mode, the GPU 133 may generate a standby screen including a graphic object in a background image. As described above, the screen including the various objects generated in the GPU 133 may be output through the image signal generator 170.

The GPU configuration may be configured as a separate configuration such as the image signal generator 170, and may be implemented as the same configuration as the SoC combined to the CPU in the processor 130.

In addition, the processor 130 may be implemented as a separate component distinguishable from the ROM, RAM, GPU, and the like, and may connect with another processor and memories.

As described above, the processor 130 may reduce power consumption of the electronic device 100 through various methods. Specifically, when operating in the content mode and when operating in the standby mode, the processor 130 may or may not apply power to the respective configurations of the electronic device 100 using different methods. For example, when operating in the content mode, the processor 130 may apply power to all configurations of the electronic device 100. However, when operating in the standby mode, the processor 130 may apply power to some configurations of the electronic device 100, and may not apply power to the remaining configurations.

Specifically, if operating in the content mode, the processor 130 may apply power to the communicator 110, the display 120, the memory 140, the broadcast receiver 150, the signal separator 155, the A/V processor 160, the audio outputter 165, the image signal generator 170, the sensor 175, and the operator 180. However, if operating in the standby mode, the processor 130 may apply power to the communicator 110, the display 120, the memory 140, and the sensor 175, but may not apply power to the remaining configurations. That is, the processor 130 may apply power to only the necessary configurations in displaying the standby screen to minimize power consumption while operating in the standby mode, and may not apply power to the configurations that are not necessary in displaying the standby screen.

In the above-described embodiment, the processor 130 has been described as applying power to the communicator 110, the display 120, the memory 140, and the sensor 175 in the standby mode, but the embodiment is not limited thereto, and applying power based on necessity may be added or omitted. In addition, the power 130 may or may not apply power of a specific configuration when a specific condition is satisfied in the standby mode.

In an embodiment, the processor 130 may apply power to the communicator 110 only when a specific condition is satisfied. Specifically, while operating in the standby mode, the processor 130 may apply power to the communicator 110 based on a predetermined time interval. That is, when it is not necessary to receive in real time the standby screen information from the server 200, the processor 130 may apply power to the communicator 110 at only the predetermined time to minimize power consumption. However, if the standby screen information is received in real time from the server 200, the processor 130 may constantly apply power to the communicator 110.

According to another embodiment, the processor 130 may apply power to the communicator 110 when a user is detected in the periphery of the electronic device 100, and may not apply power to the communicator 110 when a user is not detected in the periphery of the electronic device 100.

According to the various methods described above, the processor 130 may selectively decide the configuration of power being applied in the standby mode, and may minimize power consumption in the standby mode.

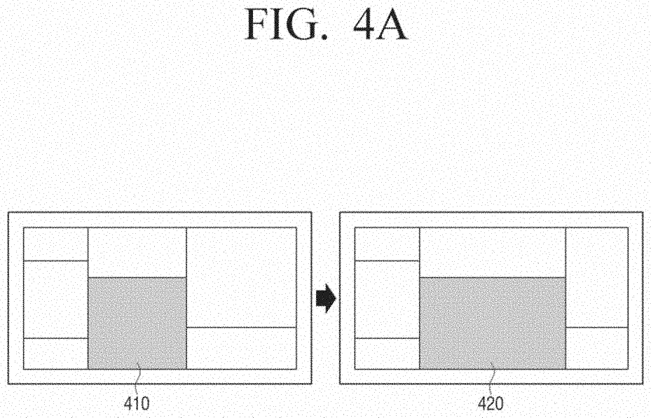

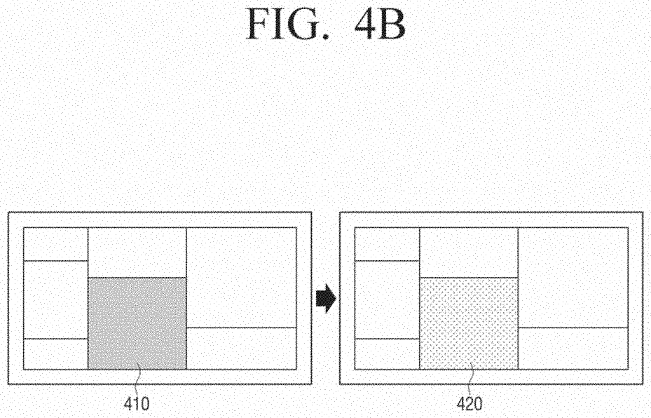

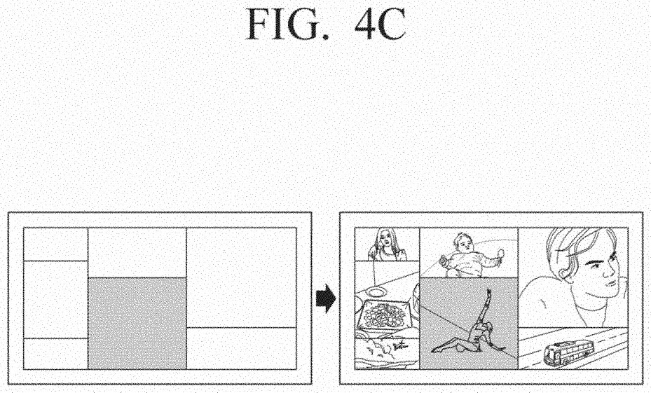

A standby screen display method according to the various embodiments of the disclosure using FIGS. 4A to 9B will be described below.

In the embodiments of most of FIGS. 4A to 8B, the left side of the standby screen indicates the current standby screen, and the right side of the standby screen may indicate a changed standby screen when new data is input.

FIGS. 4A to 4C are exemplary views illustrating a standby screen display method according to an embodiment of the disclosure.

As illustrated in FIG. 4A, the standby screen may include a plurality of block elements. As described above, each of the plurality of block elements may be an element corresponding to each of the plurality of categories. As illustrated on the left side of FIG. 4A, the standby screen may include seven block elements. At this time, each of the block elements may correspond to, for example, a sports category, a food category, a music category, an economy category, an automobile category, a health category, and a gaming category.

For example, when the block element 410 is referred to as the element corresponding to the sports category, the size of the block element 410 may be the size corresponding to the number of bookmarks related to sports. If the bookmark related to sports is added, the electronic device 100 may receive a new standby screen information from the server 200, and change the size of the block element 410 illustrated on the right side of FIG. 4A. That is, as the number of bookmarks corresponding to the sports category increases, the size of the block element 420 corresponding to the sports category may also increase. At this time, the size of each of the block elements may be decided based on the ratio of the number of bookmarks included in each category.

As illustrated in FIG. 4B, when a specific condition is satisfied, the electronic device 100 may change the color of the block. The specific condition may be, for example, a condition related to user schedule. For example, when a schedule is input, the electronic device 100 may change the block element 410 to a red color block element 420 prior to or after the starting time of the schedule. Because the user may think that an immediate to-do schedule exists after seeing the block element changing to a red color, the electronic device 100 provide the information to the user.

According to still another embodiment, the electronic device 100 may, for example, change the color of the block element at a specific time (i.e., every hour, every 30 minutes, etc.). Specifically, the electronic device may change the color of the block element to blue in between every 29 to 31 minutes of every hour. The user may see the color change of the block element, and roughly determine the current time.

As illustrated in FIG. 4C, each of the block elements may further include a thumbnail related to a category. The displayed thumbnail may be a thumbnail corresponding to the category information, and may be a thumbnail applied with an effect of pattern and texture of an existing image. The thumbnail may be displayed only when a specific condition is satisfied. For example, the standby screen may normally include only the block element as on the left side of FIG. 4C. However, when a user approaches within a pre-set distance from the electronic device 100, the standby screen may, as illustrated on the right side of FIG. 4C, display a thumbnail on the block element. That is, if there is no user or if the user is far away from the periphery of the electronic device 100, only the block element may be displayed, and if the user has approached near the electronic device 100, a thumbnail may be displayed together therewith.

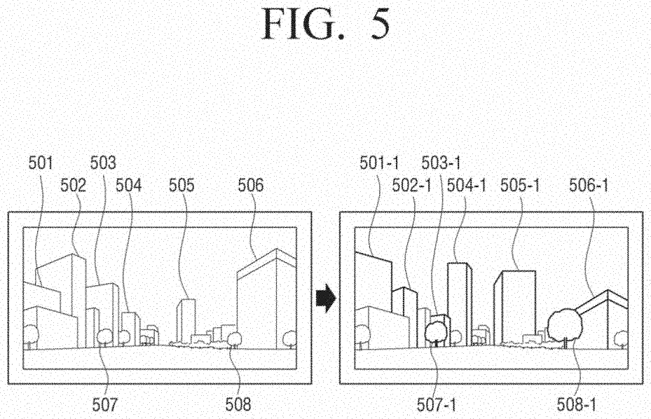

As illustrated in FIG. 5, the standby screen may be a general landscape image. The technical concept described in FIGS. 4A to 4C may be applied as is to FIG. 5 as well. The plurality of elements included in the standby screen may be buildings, trees, and the like in a landscape image. If new data is input, the electronic device 100 may receive information of the changed standby screen from the server 200, and change the standby screen as on the right side of FIG. 5. That is, the size of the building and the tree element may be changed based on the changed data.

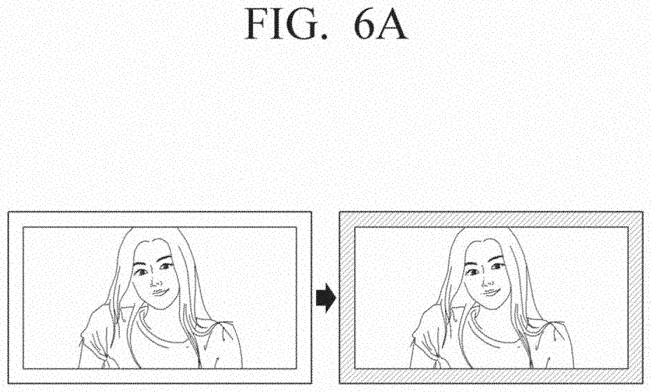

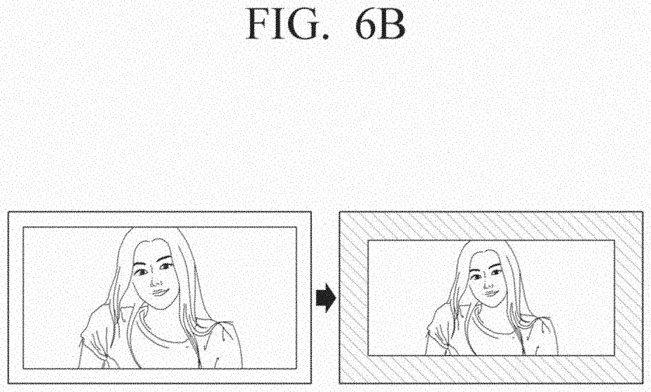

FIGS. 6A and 6B are exemplary views illustrating a change of frame according to still another embodiment of the disclosure.

As illustrated in FIG. 6A, the standby screen may include a frame. If a specific condition is satisfied, the electronic device 100 may change the frame using various methods. For example, the electronic device 100 may display a frame of a starting time of a pre-stored user schedule to a red color. Alternatively, the electronic device 100 may display a frame of a pre-stored scheduled broadcast time to a blue color. Alternatively, the electronic device 100 may display a frame in yellow color when a user has approached within a pre-set distance from the electronic device 100.

As illustrated in FIG. 6B, the electronic device 100 may not only change the color of the frame but also the size of the frame. That is, when satisfying a specific condition, the electronic device 100 may change the size of the frame. For example, if the electronic device 100 is a part of an IoT system, the electronic device 100 may change the size of the frame based on change in external devices. In an embodiment, if the electronic device 100 detects an operation of opening a door lock, which is a part of the IoT system, the size of the frame may be increased. Alternatively, if the electronic device 100 detects an operation of turning-on lighting, which is a part of the IoT system, the size of the frame may be reduced.

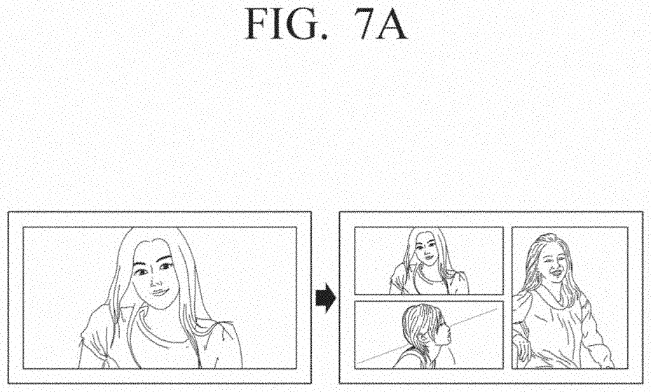

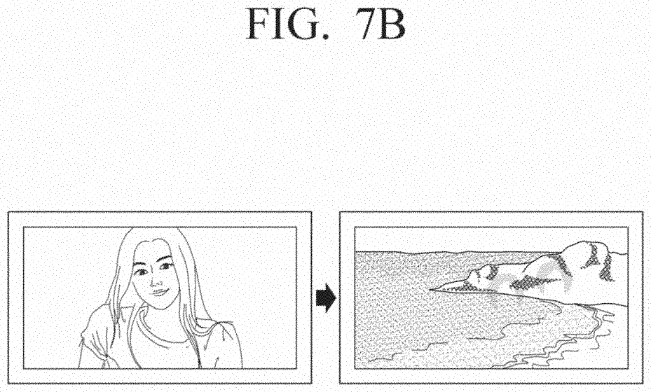

FIGS. 7A and 7B are exemplary views illustrating a method of adding a new element to a standby screen or changing to a new standby screen.

As illustrated on the left side of FIG. 7A, the electronic device 100 may display a standby screen on a first user. Specifically, the electronic device 100 may detect that a first user is in the periphery of the electronic device 100, and display the standby screen related to the first user. If a second user and a third user approaches the periphery of the electronic device 100 while a first user is present in the periphery of the electronic device 100, the electronic device 100 may detect the second user and the third user. As illustrated on the right side of FIG. 7A, the electronic device 100 may reduce the element on the first user, and add an element on the second user and the third user.

As illustrated in FIG. 7A, the electronic device 100 may include a camera configuration for detecting a first user to a third user. The electronic device 100 may identify a user in the periphery of the electronic device 100 through a camera.

In still another embodiment, the electronic device 100 may also determine the number of users without identifying the identity of the user in the periphery of the electronic device 100. That is, if the number of users in the periphery of the electronic device 100 is one person, a standby screen including one element as on the left side of FIG. 7A may be displayed, and if the number of users in the periphery of the electronic device 100 is three persons, a standby screen including three elements as on the right side of FIG. 7A may be displayed.

When new data is input, the electronic device 100 may change the standby screen based on new data. That is, if data related to travel is input while the electronic device 100 displaying a standby screen as on the left side of FIG. 7B, the electronic device 100 may display a standby screen related to travel as in the right side of FIG. 7B.

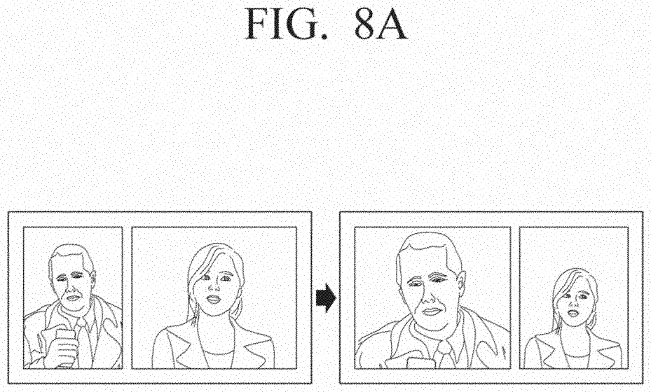

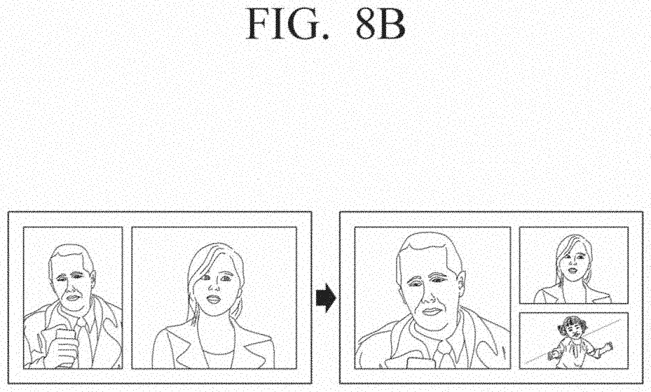

FIGS. 8A and 8B are exemplary views illustrating a method for an electronic device to display a standby screen including an element corresponding to a plurality of users.

As illustrated in FIG. 8, the electronic device 100 may display a standby screen including an element (i.e., left side element) corresponding to a first user and an element (i.e., right side element) corresponding to a second user. The element corresponding to the first user and the element corresponding to the second user may each be a configuration corresponding to data on the first user and data on the second user. That is, when data on the first user is input while the standby screen is in a state as on the left side of FIG. 8A, the electronic device 100 may change the element on the first user and the element on the second user as on the right side of FIG. 8A.

When a third user is detected in the periphery of the electronic device 100, the electronic device 100 may add an element (i.e., right side lower end element) corresponding to the third user as illustrated on the right side of FIG. 8B.

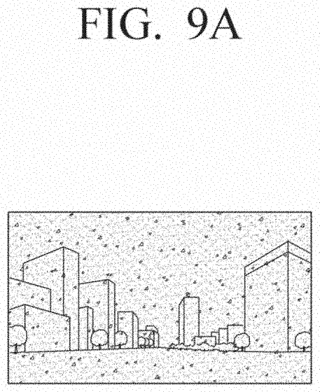

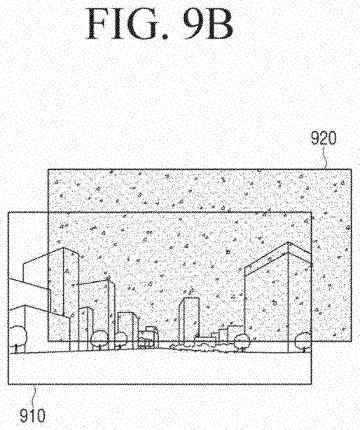

FIGS. 9A and 9B are exemplary views illustrating a display method of a standby screen according to an embodiment of the disclosure.

Specifically, the electronic device 100 may further display a graphic object corresponding to the various information on the above-described standby screens additionally. For example, the electronic device 100 may, as illustrated in FIG. 9A, display a graphic object corresponding to the current weather information. Alternatively, the electronic device 100 may also display a clock object corresponding to the current time information. Alternatively, the electronic device 100 may also display various graphic objects designated by the user additionally.

As illustrated in FIG. 9B, the graphic object may be displayed on a separate graphic layer. That is, the electronic device 100 may generate a background image layer 910 and a graphic object layer 920. The graphic object layer 920 may be disposed in front of the background image layer 910 and displayed.

In FIG. 9B, although the electronic device 100 has been described as generating and displaying only the background image layer 910 and the graphic object layer 920, other various layers may be further included. For example, the electronic device 100 may further generate a shadow layer on a shadow of an object displayed in the graphic object, and the like.

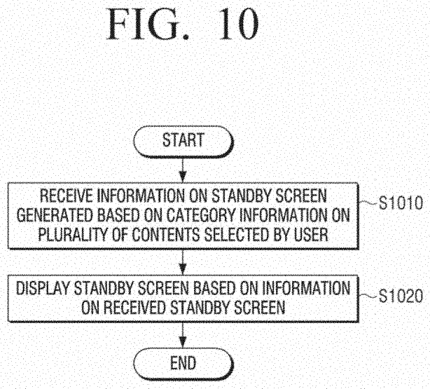

FIG. 10 is a flowchart illustrating a control method of an electronic device according to an embodiment of the disclosure.

First, the electronic device 100 may receive information on a standby screen generated based on category information on a plurality of contents selected by a user (S1010). The information on the standby screen may include information of an element corresponding to the amount of data included in each category and the amount of data included in each category.

The electronic device 100 may display a standby screen based on information on the received standby screen (S1020). The standby screen may be displayed by the various methods described above.

The devices (e.g., modules or electronic device 100) or method (e.g., operations) according to the various embodiments, may be performed by at least one computer (e.g., processor 120) executing instructions included in at least one program of the programs maintained by, for example, a computer-readable storage media.

Based on the instruction being executed by a computer (e.g., processor 130), the at least one computer may perform a function corresponding to the instruction. The computer-readable storage medium may be, for example, the memory 110.

The program may be included in a computer-readable storage medium such as a hard disk, a floppy disk, a magnetic media (e.g., magnetic tape), an optical media (e.g., compact disc read only memory (CD-ROM)), a digital versatile disc (DVD), a magneto-optical media (e.g., floptical disk), or a hardware device (e.g., ROM, RAM, flash memory, etc.). The storage medium may generally be included as part of a configuration of the electronic device 300, but may be mounted through a port of the electronic device 300, or may be included in an externally located external device (e.g., a cloud, a server, or a different electronic device) of the electronic device 300. In addition, the program may be divided and stored in a plurality of storage media, and at least a part of the plurality of storage media may be located in external devices of the electronic device 100.

The instruction may include not only machine language code as created by a compiler, but also a high level language code executable by a computer using an interpreter or the like. The hardware device described above may be configured to operate as one or more software modules to perform operations of various embodiments, and vice versa.

While the disclosure has been illustrated and described with reference to various embodiments of the disclosure, the disclosure is not limited to the specific embodiments described. It will be understood by those skilled in the art that various changes in form and details may be made therein without departing from the spirit and scope of the disclosure.

What is claimed is:

1. An electronic device, comprising:
a display;
a communicator; and
a processor configured to receive information on a standby screen generated based on category information on a plurality of contents selected by a user through the communicator, and control the display to display a standby screen based on information on the received standby screen,
wherein the standby screen comprises a plurality of elements corresponding to a plurality of categories in which the plurality of contents are classified.

2. The electronic device of claim 1, wherein the processor is configured to:
based on information on the standby screen being changed, receive the changed standby screen information through the communicator, and
control the display to display the standby screen by changing the plurality of elements based on the changed standby screen information.

3. The electronic device of claim 1, wherein the processor is configured to:
control the display to display the standby screen in a standby mode, and
control the display to display content in a content mode.

4. The electronic device of claim 3, wherein the processor is configured to, based on power being applied to the display for operating in the standby mode while in a state in which power is not applied to the display, receive information on a standby screen generated based on category information on a plurality of contents selected by a user through the communicator.

5. The electronic device of claim 3, wherein the processor is configured to, based on the display being changed from the content mode to the standby node, receive information on a standby screen generated based on category information on a plurality of contents selected by a user through the communicator.

6. The electronic device of claim 1, wherein change in the element is one of deleting any one of the at least one element, adding new element, and changing a size or a color of the element.

7. The electronic device of claim 3, wherein the processor is configured to, based on the electronic device operating in the standby mode, control the display to display a background image layer comprising the at least one element and a screen comprising an object layer comprising a graphic object.

8. The electronic device of claim 7, wherein the processor is configured to, based on the electronic device operating in the standby mode, control the display to display a weather graphic object corresponding to an outside weather information on the object layer.

9. A control method of an electronic device, the method comprising:
receiving information on a standby screen generated based on category information on a plurality of contents selected by a user; and
displaying a standby screen based on information on the received standby screen,
wherein the standby screen comprises a plurality of elements corresponding to a plurality of categories in which the plurality of contents is classified.

10. The control method of claim 9, wherein the displaying further comprises:
based on information on the standby screen having been changed, receiving the changed standby screen information, and displaying the standby screen by changing the plurality of elements based on the changed standby screen information.

11. The control method of claim 9, wherein the displaying comprises controlling the display to display the standby screen in a standby mode, and displaying content in a content mode.

12. The control method of claim 11, wherein the receiving comprises, based on power being applied to the display for operating in the standby mode while in a state in which power is not applied to the display of the electronic device, receiving information on a standby screen generated based on category information on a plurality of contents selected by a user.

13. The control method of claim 11, wherein the receiving comprises, based on a display of the electronic device being changed from the content mode to the standby mode, receiving information on a standby screen generated based on category information on a plurality of contents selected by a user.

14. The control method of claim 9, wherein the changing of the element is one of deleting any one of the at least one element, adding new element, and changing a size or color of the element.

15. The control method of claim 11, wherein the displaying further comprises:
based on the electronic device operating in the standby mode, displaying a screen comprising a background image layer comprising a background image layer comprising the at least one element and an object layer comprising a graphic object.
